(19) United States
(12) Patent Application Publication
(10) Pub. No.: US 2025/0033416 A1
(43) Pub. Date: Jan. 30, 2025

(54) NON-PNEUMATIC TIRE AND A SYSTEM AND METHOD OF MAKING SAME

(71) Applicant: Bridgestone Bandag, LLC, Nashville, TN (US)

(72) Inventors: Wade L. Terrill, Letts, IA (US); Merle R. Schlapkohl, Durant, IA (US); Alexander G. Tomtschik, Muscatine, IA (US); Chad M. Zeck, Muscatine, IA (US); Terry A. Westway, Conesville, IA (US)

(21) Appl. No.: 18/716,752

(22) PCT Filed: Dec. 14, 2022
(86) PCT No.: PCT/US2022/081489

§ 371 Date: Jun. 5, 2024

Related U.S. Application Data
(60) Provisional application No. 63/295,566, filed on Dec. 31, 2021.

(51) Int. Cl. B60C 7/14; B29D 30/02

(52) U.S. Cl. CPC B60C 7/146; B29D 30/02

(57) ABSTRACT

A system for assembling a tread and a non-pneumatic tire structure includes a curing envelope dimensioned to receive an upper ring of a non-pneumatic tire structure and a circumferential tread. The curing envelope includes a first side configured to be secured to a bottom of a first ledge of the upper ring. The curing envelope also includes a second side configured to be secured to a bottom of a second ledge of the upper ring. The system further includes a first fastener configured to secure the first side of the curing envelope to the bottom of the first ledge of the upper ring. The system also includes a second fastener configured to secure the second side of the curing envelope to the bottom of the second ledge of the upper ring.

### FIELD OF INVENTION

The present disclosure relates to a non-pneumatic tire and a system and a method of making the same. More specifically, the present disclosure relates to a system and method of applying a tread to a non-pneumatic tire structure.

### BACKGROUND

Various tire constructions have been developed which enable a tire to run in an uninflated or underinflated condition. Non-pneumatic tires do not require inflation, while “run flat tires” may continue to operate after receiving a puncture and a complete or partial loss of pressurized air, for extended periods of time and at relatively high speeds. Non-pneumatic tires may include a plurality of spokes, a webbing, or other support structure that connects a lower ring to an upper ring. It is known to adhere a pre-cured tread to an upper ring of a non-pneumatic with adhesive or cement.

### SUMMARY OF THE INVENTION

In one embodiment, a method of making a non-pneumatic tire includes providing a tire structure having a lower ring having a first diameter and a first width, and an upper ring having a second diameter greater than the first diameter and a second width, the upper ring being substantially coaxial with the lower ring. The tire structure further includes a support structure extending between the lower ring and the upper ring. The support structure has a third width that is less than the second width, such that a first side of the upper ring extends outward from a first side of the support structure, thereby defining a first ledge. Additionally, a second side of the upper ring extends outward from a second side of the support structure, thereby defining a second ledge. The method further includes providing an elastomeric tread circumferentially about a top of the upper ring, and securing a curing envelope about the elastomeric tread. The securing of the curing envelope includes the steps of securing a first side of the curing envelope to a bottom of the first ledge of the upper ring and securing a second side of the curing envelope to a bottom of the second ledge of the upper ring. The method also includes applying heat within the curing envelope.

In another embodiment, a system for assembling a circumferential tread and a non-pneumatic tire structure is provided, wherein the tire structure has an upper ring, a lower ring, and support structure extending between the upper ring and the lower ring. The system includes a curing envelope dimensioned to receive an upper ring of a non-pneumatic tire structure and a circumferential tread. The curing envelope includes a first side configured to be secured to a bottom of a first ledge of the upper ring. The curing envelope also includes a second side configured to be secured to a bottom of a second ledge of the upper ring. The system further includes a first fastener configured to secure the first side of the curing envelope to the bottom of the first ledge of the upper ring. The system also includes a second fastener configured to secure the second side of the curing envelope to the bottom of the second ledge of the upper ring.

In yet another embodiment, a non-pneumatic tire includes a lower ring having a first diameter and a first width, and an upper ring having a second diameter greater than the first diameter and a second width. The upper ring is substantially coaxial with the lower ring. The non-pneumatic tire further includes a support structure extending between the lower ring and the upper ring. The support structure has a third width that is less than the second width. The support structure is affixed to the upper ring such that a first side of the upper ring extends outward from a first side of the support structure, thereby defining a first ledge. The support structure is affixed to the upper ring such that a second side of the upper ring extends outward from a second side of the support structure, thereby defining a second ledge. The non-pneumatic tire further includes an elastomeric tread circumferentially affixed to a top of the upper ring. No pressure-sensitive adhesive is disposed between the upper ring and the elastomeric tread.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale, and the proportion of certain elements may be exaggerated for the purpose of illustration.

FIG. 1 is a perspective view of one embodiment of a non-pneumatic tire,

FIG. 2 is an enlarged partial perspective view of the non-pneumatic tire of FIG. 1,

FIG. 3 is a schematic drawing illustrating a cross-section of one embodiment of a non-pneumatic tire,

FIG. 4 is a schematic drawing illustrating a cross-section of an alternative embodiment of a non-pneumatic tire,

FIG. 5 is an enlarged partial perspective view of another alternative embodiment of a non-pneumatic tire,

FIG. 6 is a schematic drawing illustrating a perspective view of one embodiment of a curing envelope for a non-pneumatic tire,

FIG. 7 is a front view of one embodiment of an arc adjustable band and ratchet assembly,

FIG. 8 is an enlarged front view of one embodiment of the ratchet assembly of FIG. 7,

FIG. 9 is a perspective view of the arc adjustable band and ratchet assembly of FIG. 7,

FIG. 10 is a schematic drawing of a top view of one embodiment of a reverse hose clamp,

FIG. 11 is a front view of the reverse hose clamp of FIG. 10 with a helicoid screw assembly,

FIG. 12 is a front view of one embodiment of a helicoid screw,

FIG. 13 is a front view of one embodiment of a sealing ring,

FIG. 14 is a partial cross-section of the sealing ring of FIG. 13,

FIG. 15 is a front view of one embodiment of a snap ring,

FIGS. 16A and 16B are front views of an expansion ring in closed and opened positions, respectively,

FIG. 17 is a front view of the arc adjustable band of FIGS. 7-9 with a flat, elastomeric belt disposed about the outer circumference of the band, and

FIG. 18 is a front view of one embodiment of a hanger for a non-pneumatic tire.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Axial” and “axially” refer to a direction that is parallel to the axis of rotation of a tire.

“Circumferential” and “circumferentially” refer to a direction extending along the perimeter of the surface of the tread perpendicular to the axial direction.

“Radial” and “radially” refer to a direction perpendicular to the axis of rotation of a tire.

“Tread” as used herein, refers to that portion of the tire that comes into contact with the road or ground under normal inflation and normal load.

While similar terms used in the following descriptions describe common tire components, it should be understood that because the terms carry slightly different connotations, one of ordinary skill in the art would not consider any one of the following terms to be purely interchangeable with another term used to describe a common tire component.

Directions are stated herein with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” or “top” and “bottom” are used in connection with an element, the “upper” or “top” element is spaced closer to the tread than the “lower” or “bottom” element. Additionally, when relative directional terms such as “above” or “below” are used in connection with an element, an element that is “above” another element is closer to the tread than the other element.

The terms “inward” and “inwardly” refer to a general direction towards the equatorial plane of the tire, whereas “outward” and “outwardly” refer to a general direction away from the equatorial plane of the tire and towards the sidewall of the tire. Thus, when relative directional terms such as “inner” and “outer” are used in connection with an element, the “inner” element is spaced closer to the equatorial plane of the tire than the “outer” element.

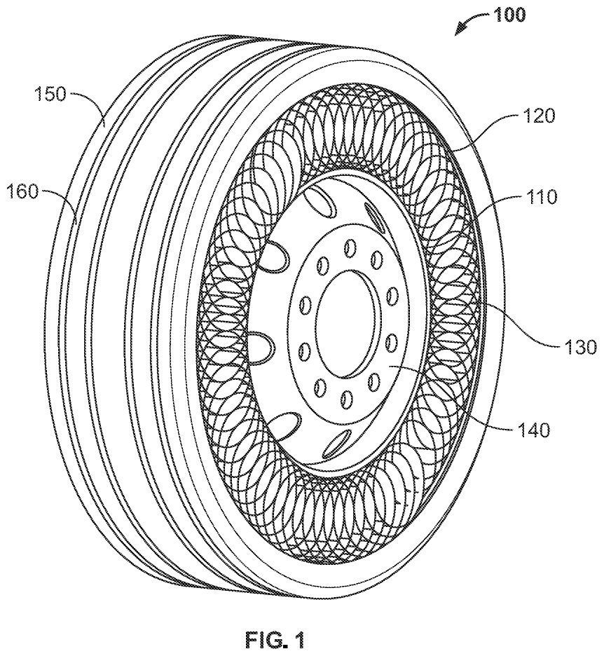

FIG. 1 is a perspective view of one embodiment of a non-pneumatic tire 100. The non-pneumatic tire 100 includes a lower ring 110 having a first diameter, and an upper ring 120 having a second diameter greater than the first diameter. The upper ring 120 is substantially coaxial with the lower ring 110. A plurality of spokes 130 extend between the lower ring 110 and the upper ring 120. In an alternative embodiment, a webbing or other support structure may be employed instead of spokes. It should be understood that the term “support structure” may refer to either webbing or spokes.

In one embodiment, each of the lower ring 110, upper ring 120, and spokes 130 are constructed of the same material. In one particular embodiment, each of the lower ring 110, upper ring 120, and spokes 130 are constructed of steel. In alternative embodiments, each of the lower ring 110, upper ring 120, and spokes 130 are constructed of other metal, carbon fiber, resin, or a polymeric material such as polyurethane, polyester, nylon, or polyvinyl chloride (PVC). It should be understood, however, that other materials may be used and the rings and spokes are not limited to the listed materials.

In an alternative embodiment, one or more of the lower ring 110, upper ring 120, and spokes 130 are constructed of different materials. For example, the upper ring 120 may be a steel band while the lower ring 120 and spokes 130 are constructed of other metal, carbon fiber, resin, or a polymeric material such as polyurethane, polyester, nylon, or polyvinyl chloride (PVC).

In the illustrated embodiment, the lower ring 110 is shown as being attached to a hub 140. It should be understood that the illustrated hub is merely exemplary, and that the lower ring 110 may be attached to any hub or wheel structure.

A circumferential tread 150 is disposed about the upper ring 120 in the illustrated embodiment. The circumferential tread 150 may be constructed of an elastomeric material, such as natural or synthetic rubber. The tread 150 is shown as having a plurality of circumferential grooves that define a plurality of ribs. It should be understood that the tread may also include tread elements such as lateral grooves, ribs, blocks, lugs, sipes, studs, and other elements. A shear band or other shear element or reinforcement structure (not shown) may be disposed between the upper ring 120 and the tread 140. Alternatively, a shear band or other shear element may be disposed within the tread.

In one embodiment, the circumferential tread 150 is affixed to a top of the upper ring 120, with no pressure-sensitive adhesive disposed between the upper ring 120 and the circumferential tread 150. In one such embodiment, the circumferential tread is 150 bonded directly to the top of the upper ring 120. In another such embodiment, a strip of cured rubber (not shown) or a temperature sensitive adhesive is disposed between the circumferential tread 150 and the upper ring 120.

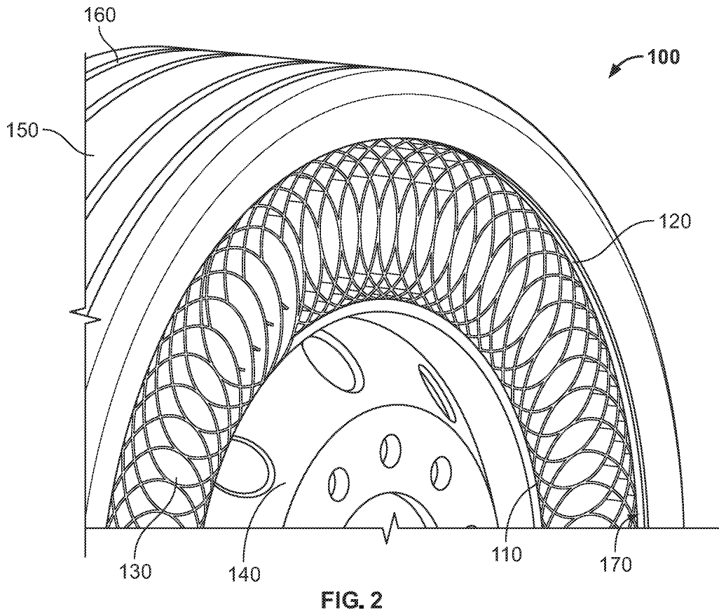

FIG. 2 is an enlarged partial perspective view of the non-pneumatic tire of FIG. 1. As can be seen in this view, the spokes 130 are a plurality of curved or arcuate spokes that intersect each other. It should be understood, however, that the illustrated spokes are merely exemplary. In other embodiments, the spokes may be straight or multi-segmented. Additionally, non-intersecting spokes may be employed.

As can be seen in this view, the upper ring 120 has a greater width than the spokes 130, such that the upper ring 120 extends outward from spokes 130, thereby defining a ledge 170. The ledge 170 may also be referred to as a ceiling. In one embodiment, the ledge 170 has a width between 0.375 inches (0.95 cm) and 1 inch (2.54 cm). In an alternative embodiment, the ledge may have a width between 0.25 inches (0.64 cm) and 1.5 inches (3.8 cm).

From this view, the ledge 170 is shown on only one side of the tire. It should be understood, however, that the spokes 130 are affixed to the upper ring 120 such that a first side of the upper ring 120 extends outward from a first side of the spokes 130, thereby defining a first ledge 170 and a second side of the upper ring 120 extends outward from a second side of the spokes 130, thereby defining a second ledge (not shown). In one embodiment, the first ledge has a width equal to the width of the second ledge. In alternative embodiments, the first ledge is wider than the second ledge.

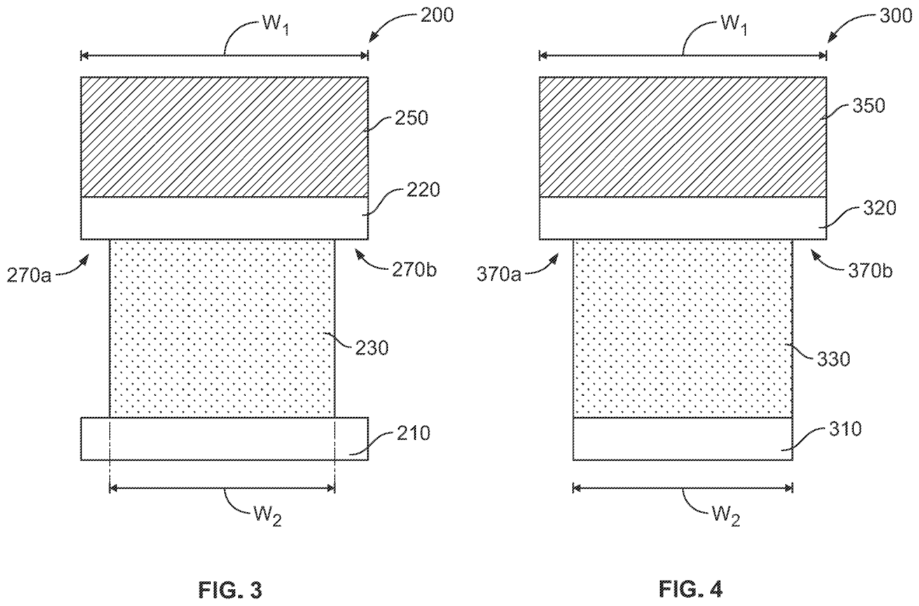

The relative dimensions of the non-pneumatic tire structure may vary. For example, FIGS. 3 and 4 are schematic drawings illustrating cross-sections of two embodiments of a non-pneumatic tire. In FIG. 3, a non-pneumatic tire 200 includes a lower ring 210, an upper ring 220, and support structure 230 extending between the lower ring 210 and the upper ring 220. A circumferential tread 250 is disposed on a top surface of the upper ring 220. The support structure 230 may be spokes, webbing, or other support structure. While the support structure 230 is shown as being continuous in the axial direction, in other embodiments the support structure is axially discontinuous.

In this embodiment, the lower ring 210, upper ring 220, and circumferential tread 250 each have substantially the same first axial width W₁. The support structure 230 has a second axial width W₂ that is less than the first axial width W₁. Thus, the upper ring 220 extends outwards from the support structure 230 on both sides of the non-pneumatic tire 200, thereby defining a first ledge 270a on a first side of the tire 200, and a second ledge 270b on a second side of the tire 200.

Additionally, in this embodiment the lower ring 210 also extends outward from the support structure 230 and forms a ledge on each side of the tire 200.

In alternative embodiments (not shown), the tread may be wider or narrower than the upper ring.

In FIG. 4, a non-pneumatic tire 300 includes a lower ring 310, an upper ring 320, and support structure 330 extending between the lower ring 310 and the upper ring 320. A circumferential tread 350 is disposed on a top surface of the upper ring 320. The support structure 330 may be spokes, webbing, or other support structure. While the support structure 330 is shown as being continuous in the axial direction, in other embodiments the support structure is axially discontinuous.

In this embodiment, the upper ring 320 and circumferential tread 350 each have substantially the same first axial width W₁. The lower ring 310 and the support structure 230 each have substantially the same second axial width W₂ that is less than the first axial width W₁. Thus, the upper ring 320 extends outwards from the support structure 330 on both sides of the non-pneumatic tire 300, thereby defining a first ledge 370a on a first side of the tire 300, and a second ledge 370b on a second side of the tire 300.

In this embodiment, the lower ring 310 is flush with the support structure 330.

In alternative embodiments (not shown), the tread may be wider or narrower than the upper ring.

It should be understood that FIGS. 3 and 4 are merely exemplary, and that the relative widths of each component of the non-pneumatic tire may vary.

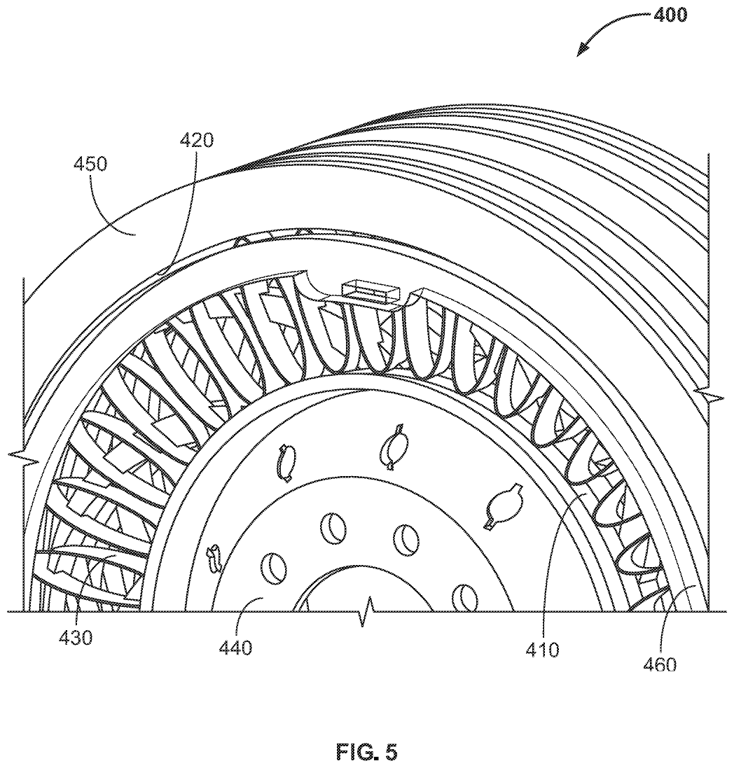

FIG. 5 is an enlarged partial perspective view of another alternative embodiment of a non-pneumatic tire 400. The non-pneumatic tire 400 includes a lower ring 410 having a first diameter, and an upper ring 420 having a second diameter greater than the first diameter. The upper ring 420 is substantially coaxial with the lower ring 410. A plurality of spokes 430 extend between the lower ring 410 and the upper ring 420. The lower ring 410 is attached to a hub 440. A circumferential tread 450 is disposed about the upper ring 420.

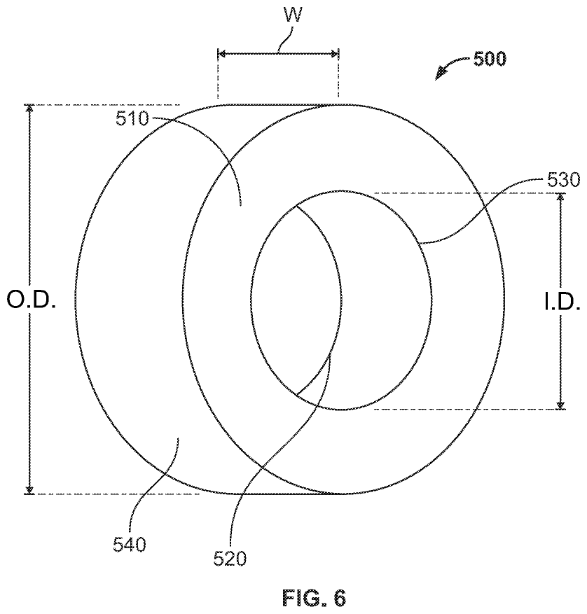

The sides of the upper ring 420 extend outward beyond the spokes 430, thereby defining a ledge on each side of the tire. During a process of making the non-pneumatic tire 400, each ledge may receive a securing element or fastener, such as the band 460 shown here, to secure a curing envelope, such as the curing envelope 500 shown in FIG. 6, about the circumferential tread 450.

With continued reference to FIG. 6, the curing envelope 500 is dimensioned to receive an upper ring of a non-pneumatic tire structure and a circumferential tread, without extending to the spokes or support structure. The curing envelope 500 has a pair of sides 510, which terminate at a first end 520 and a second end 530. The first and second ends 520, 530 each define an inner diameter ID of the curing envelope 500. The inner diameter ID may be between 22 inches (56 cm) and 58 inches (147 cm). While the sides 510 are shown as being flat, it should be understood that they may be curved or contoured as desired.

The curing envelope also has a top 540 defining an outer diameter OD. The outer diameter OD may be between 28 inches (71 cm) and 60 inches (152 cm). While the top 540 is shown as being flat, it should be understood that it may be curved or contoured as desired. In one embodiment, the sides 510 of the curing envelope 500 have a length between 2 to 6 inches (5 to 15 cm). In other words, the outer diameter OD is 2 to 6 inches greater than the inner diameter ID.

The curing envelope 500 may be a sheet of butyl rubber, other rubber compounds, neoprene, polytene, latex, or other flexible materials. The sheet of material may have a thickness between 0.008 inches (0.02 cm) and 0.12 inches (0.3 cm). The sheet may be damaged or torn by any sharp edges on the spokes or support structure of a non-pneumatic tire. Thus, it is advantageous for the first and second ends 510, 520 to be secured to an upper ring of a non-pneumatic tire rather than extend to the spokes or support structure.

The curing envelope 500 and the band 460 or other such fastener may be used in a method of making a non-pneumatic tire. Such a method includes a step of providing a tire structure having a lower ring, an upper ring, and support structure, such as any of the tire structures described above with respect to FIGS. 1-5.

In other words, the support structure has a width that is less than a width of the upper ring, such that a first side of the upper ring extends outward from a first side of the support structure, thereby defining a first ledge, and such that a second side of the upper ring extends outward from a second side of the support structure, thereby defining a second ledge. The method further includes providing an elastomeric tread circumferentially about a top of the upper ring, and securing a curing envelope about the elastomeric tread. The step of securing the curing envelope includes the steps of securing a first side of the curing envelope to a bottom of the first ledge of the upper ring and securing a second side of the curing envelope to a bottom of the second ledge of the upper ring.

The method further includes applying heat and pressure within the curing envelope. In one embodiment, heat is applied at a temperature between 200° F. and 300° F. (90° C. to 150° C.). The elastomeric tread may be a pre-cured or a partially cured tread, having any desired tread elements pre-formed before the tread is provided about the upper ring. Because the elastomeric tread is pre-cured or partially cured, the tread is only heated to a sufficient temperature to bond the tread to the upper ring.

In one embodiment, a strip of green rubber or a temperature sensitive adhesive is first applied to either the tread or the upper ring. In such an embodiment, the applied heat causes the green rubber or the adhesive to bond the tread to the upper ring.

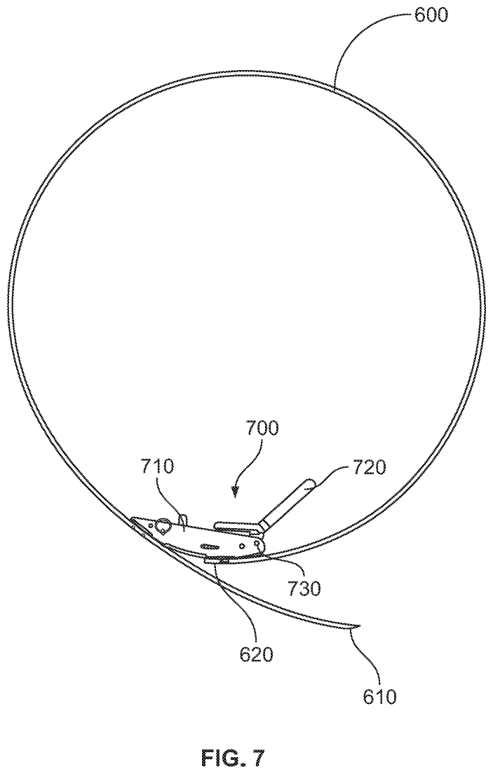

While the method of making a tire has been described with the use of a simple band 460 as a fastener, other types of fasteners may be employed. Exemplary fasteners are shown in FIGS. 7-17. It should be understood that these examples are not intended to be limiting and that other fasteners may be employed.

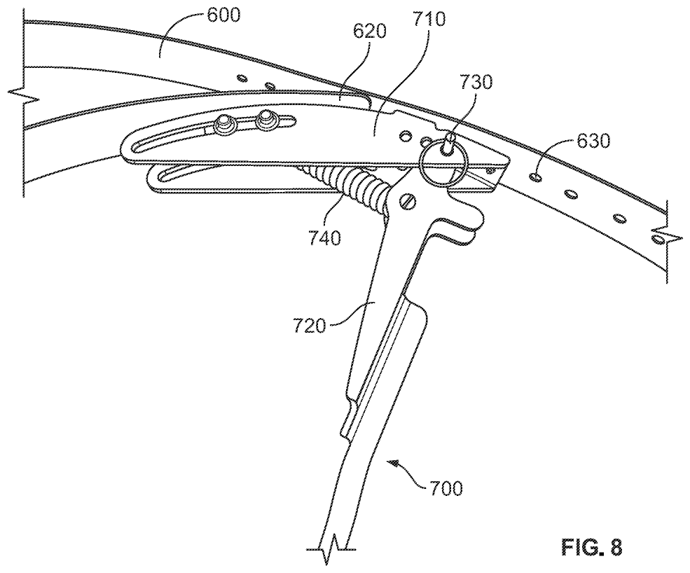

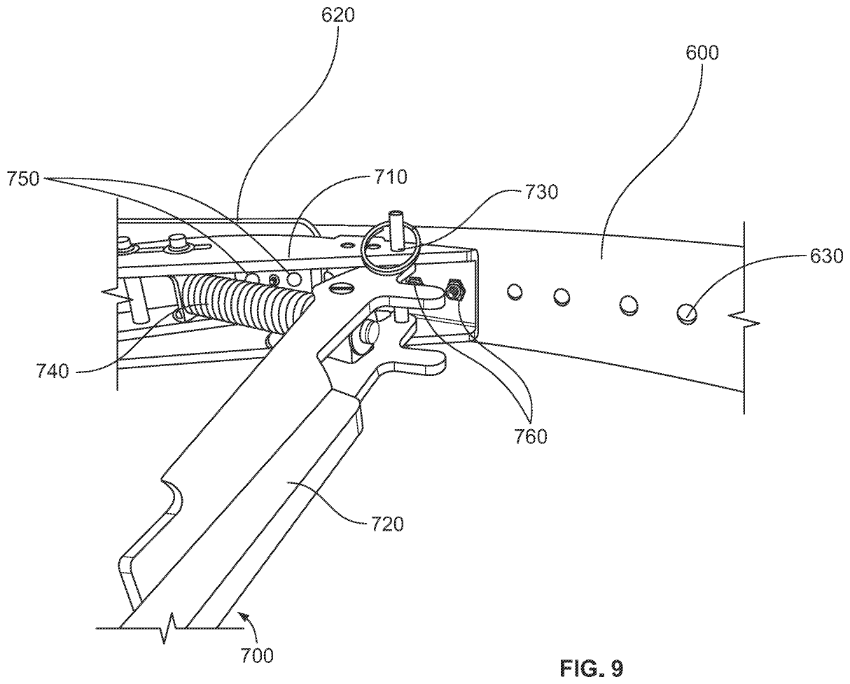

FIG. 7 is a front view of one embodiment of an arc adjustable band 600 and ratchet assembly 700. FIGS. 8 and 9 show additional views of the arc adjustable band 600 and ratchet assembly 700. The arc adjustable band 600 and ratchet assembly 700 are described herein with reference to each of FIGS. 7-9.

The arc adjustable band 600 has a first end 610 and a second end 620. The first end 610 has a plurality of apertures 630 along its length, and the second end 620 has a ratchet assembly 700 secured thereto. In the illustrated embodiment, the ratchet assembly is configured to engage at least one of the apertures 630 to maintain the adjustable band 600 in a substantially circular configuration. The arc adjustable band 600 may be made of steel or other metal or rigid material.

The ratchet assembly 700 includes a main body 710 and a handle 720. The handle 720 is pivotally connected to the main body 710 at a pivot point 730. A spring mechanism 740 is connected between the main body 710 and the handle 720, and biases the ratchet assembly 700 towards an opened position or a closed position.

The main body 710 of the ratchet assembly 700 has a curved or arc shape corresponding to the round shape of the arc adjustable band 600. The main body 710 is fixedly attached to the second end 620 of the arc adjustable band 600. As shown in FIG. 9, the main body 710 is attached to the second end 620 with rivets 750 in this embodiment. In alternative embodiments (not shown), the main body may be attached to the second end by welding or braising, or with adhesive, bolts, or other known fasteners. In another alternative embodiment, the main body may be removeably attached to the second end of the arc adjustable band.

The handle 720 of the ratchet assembly 700 is removeably attached to the first end 610 of the arc adjustable band 600. As shown in FIG. 9, the handle 720 is attached by a pair of bolts 760 that extend through two selected apertures 630 in the first end 610 of the arc adjustable band 600.

In operation, the handle 720 of the ratchet assembly 700 may be moved to a first position, in which the bolted end of handle 720 is proximate to the riveted portion of the main body 710. In this first position, the arc adjustable band 600 has a minimum diameter and it may be inserted into or removed from a sealing position with respect to a curing envelope and a non-pneumatic tire. When the arc adjustable band 600 is in a sealing position, the handle 720 may then be moved to a second position, in which the bolted end of handle 720 is distal from the riveted portion of the main body 710. In this second position, the arc adjustable band 600 has a maximum diameter, and abuts an end of the curing envelope and a ledge of an outer ring of the non-pneumatic tire. Thus, the arc adjustable band 600 seals the curing envelope against the non-pneumatic tire.

In one embodiment, the width of the arc adjustable band 600 is equal to the width of the ledge of the outer ring of the non-pneumatic tire. In an alternative embodiment, the arc adjustable band is narrower than the ledge of the outer ring of the non-pneumatic tire. In another alternative embodiment, the arc adjustable band is wider than the ledge of the outer ring of the non-pneumatic tire.

In the illustrated embodiment, the bolts 760 may be removed from the arc adjustable band 600 to allow the user to attach the handle 720 to a different location of the arc adjustable band 600, through a different selected pair of apertures 630 as desired. Thus, the diameter of the arc adjustable band 600 may be adjusted to seal a curing envelope for non-pneumatic tires of different sizes.

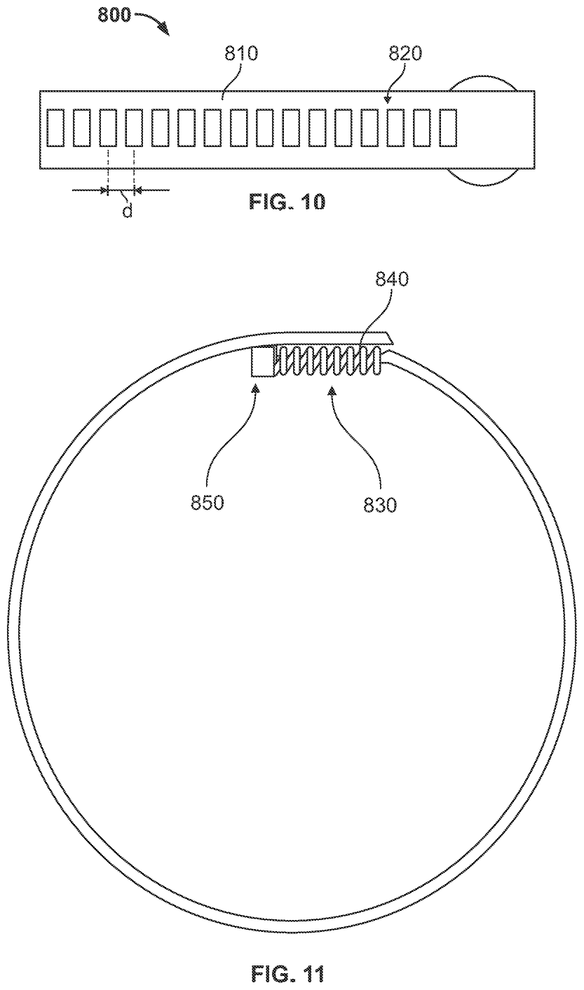

In another embodiment, a reverse hose clamp may be employed as a fastener instead of an arc adjustable band. FIGS. 10 and 11 are schematic drawings of a top view and side view, respectively, of one embodiment of a reverse hose clamp 800. The reverse hose clamp 800 includes a band 810 having a plurality of slots 820, with each slot separated by the same distance d. The band 810 may be made of steel or another metal or rigid material.

As can be seen in FIG. 11, a helicoid screw (or worm gear) 830 is attached to an inner surface of the band 810. The helicoid screw 830 is similar to that used in a traditional hose clamp that is fitted about an exterior surface of a hose. A traditional hose clamp, however, has a helicoid screw or worm gear on an external surface of a band. Here, the term “reverse hose clamp” refers to the reverse orientation of the helicoid screw 830. A “reverse hose clamp” is not limited to clamps used with hoses.

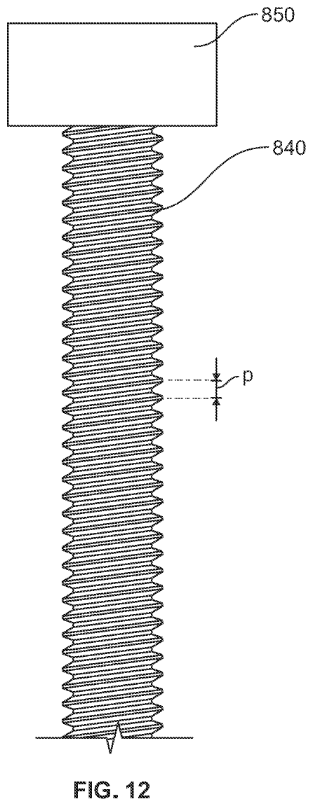

One example of a helicoid screw 830 is shown in FIG. 12. The helicoid screw 830 includes a threaded rod 840 and a head 850. The threads of the threaded rod 840 have a pitch p corresponding to the distance d between the slots 820 of the band 810. Thus, the thread engages the slots 820. When the head 850 of the helicoid screw 830 is rotated in a first direction, the rotation of the threaded rod 840 will engage the slots 820 and cause the band 810 to move towards a smaller diameter position, such that it may be inserted into or removed from a sealing position with respect to a curing envelope and a non-pneumatic tire. When the reverse hose clamp 800 is in a sealing position, the head 850 of the helicoid screw 830 may then be rotated in a second direction. The resulting rotation of the threaded rod 840 will likewise engage the slots 820 and cause the band 810 to move towards a larger diameter position until the band 810 abuts an end of the curing envelope and a ledge of an outer ring of the non-pneumatic tire. Thus, the reverse hose clamp 800 seals the curing envelope against the non-pneumatic tire.

The helicoid screw 830 may be rotated by hand. Alternatively, the helicoid screw 830 may be manually rotated with a tool, such as a screwdriver. In another alternative embodiment, the helicoid screw 830 may be rotated by an automated system.

In one embodiment, the width of the band 810 is equal to the width of the ledge of the outer ring of the non-pneumatic tire. In an alternative embodiment, the band is narrower than the ledge of the outer ring of the non-pneumatic tire. In another alternative embodiment, the band is wider than the ledge of the outer ring of the non-pneumatic tire.

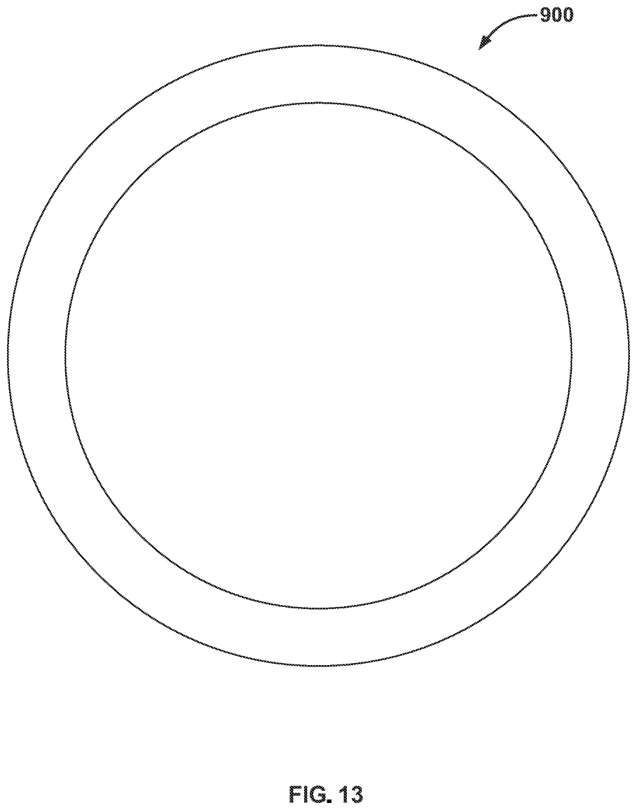

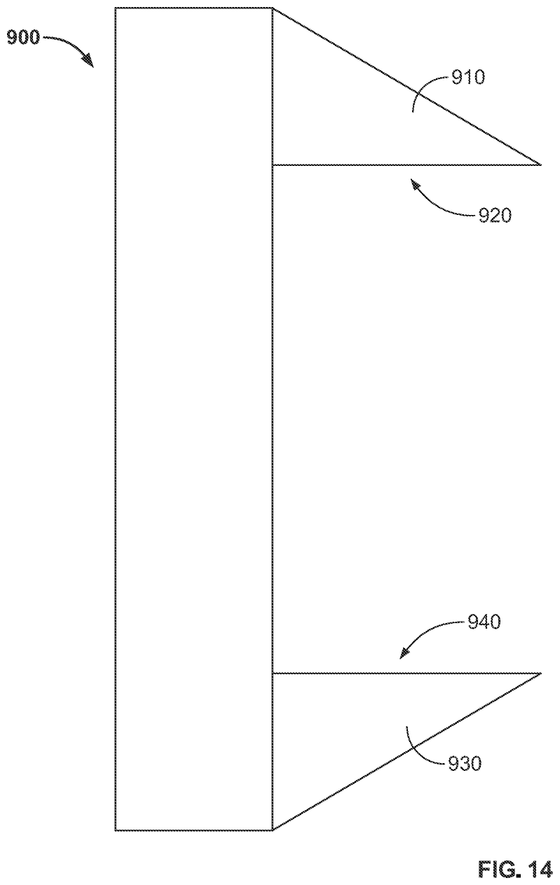

In yet another embodiment, a flanged sealing ring may be employed as a fastener instead of an arc adjustable band or a reverse hose clamp. FIGS. 13 and 14 provide a front view and partial cross-section, respectively, of one embodiment of a sealing ring 900. The sealing ring 900 includes an upper flange 910 having a flat bottom surface 920 and a lower flange 930 having a flat top surface 940. The upper flange 910 and lower flange 930 are spaced apart by a distance substantially the same as a combined height of an upper ring and a circumferential tread of a non-pneumatic tire.

In one embodiment, the entire sealing ring 900 is constructed of an elastomer or other resilient material. In an alternative embodiment, the sealing ring 900 may be constructed of multiple materials. For example, the inner core may be constructed of aluminum, other metal, polyethylene, or other rigid materials while the flanges 910, 930 are constructed of rubber or another elastomeric material.

In operation, after a curing envelope is placed about a non-pneumatic tire and tread assembly, the sealing ring 900 is secured to the curing envelope and non-pneumatic tire assembly by abutting the upper flange 910 against the curing envelope over the tread and abutting the lower flange 930 against the curing envelope under a ledge of the upper ring. The upper and lower flanges 910, 930 may flex to receive the non-pneumatic tire. After they close on the curing envelope, the flanges will exert a sealing force against the curing envelope and the tire.

In one embodiment, the width of the top surface 940 of the bottom flange 930 is equal to the width of the ledge of the outer ring of the non-pneumatic tire. In an alternative embodiment, the width of the top surface 940 of the bottom flange 930 is less than the width of the ledge of the outer ring of the non-pneumatic tire. In another alternative embodiment, the width of the top surface 940 of the bottom flange 930 is greater than the width of the ledge of the outer ring of the non-pneumatic tire.

While in the illustrated embodiment, the top flange 910 has a width that is substantially the same as the width of the bottom flange 930, in alternative embodiments (not shown), the top flange may be wider or narrower than the bottom flange. Additionally, while the illustrated embodiment shows the top flange 910 as having an angled top surface and the bottom flange 930 as having an angled bottom surface, in alternative embodiments (not shown) these surfaces may have any geometry.

Additionally, the flanges 910, 930 are not limited to having flat surfaces 920, 940. In an alternative embodiment (not shown), the bottom surface of the top flange may be contoured to correspond to a surface of the top surface of a tread of a non-pneumatic tire. Likewise, the top surface of the bottom flange may be contoured to correspond to a surface of the ledge of the upper ring of a non-pneumatic tire.

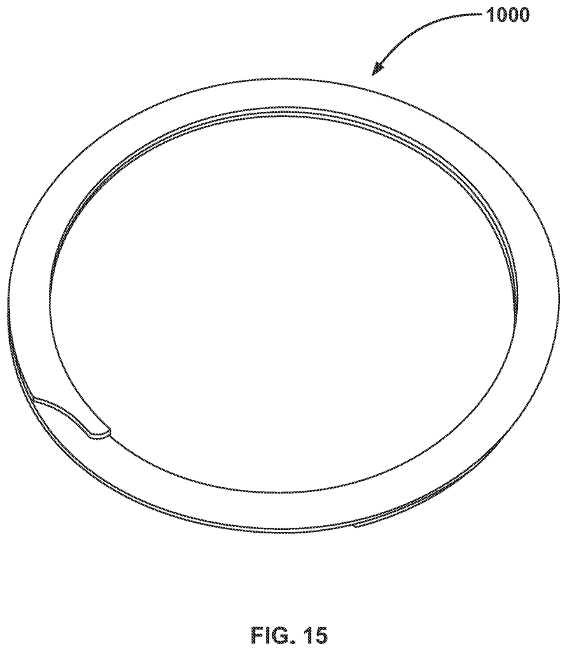

In still another embodiment, a snap ring may be employed as a fastener instead of an arc adjustable band, a reverse hose clamp, or a flanged sealing ring. For example, FIG. 15 is a front view of one embodiment of a compressible snap ring 1000. The compressible snap ring 1000 is constructed of a rigid material, such as steel, aluminum, other metal, or a hard polymeric material. However, it should be understood that while the compressible snap ring 1000 is constructed of a rigid material, the ring 1000 is sufficiently flexible to be compressed to a smaller diameter.

In operation, when the compressible snap ring 1000 is compressed to a smaller diameter, it may be inserted into or removed from a sealing position with respect to a curing envelope and a non-pneumatic tire. When the ring 1000 is in a sealing position, it may then be released such that it expands to a larger diameter. When the ring 1000 expands to a larger diameter, it abuts an end of the curing envelope and a ledge of an outer ring of the non-pneumatic tire. Thus, the ring 1000 seals the curing envelope against the non-pneumatic tire.

In one embodiment, the width of the compressible snap ring 1000 is equal to the width of the ledge of the outer ring of the non-pneumatic tire. In an alternative embodiment, the compressible snap ring is wider than the ledge of the outer ring of the non-pneumatic tire. In another alternative embodiment, the compressible snap ring is narrower than the ledge of the outer ring of the non-pneumatic tire. In one such embodiment, the snap ring may be significantly narrower than the ledge of the outer ring. For example, the compressible snap ring may have a thickness of 0.25 inches. Where the compressible snap ring is significantly narrower than the width of the ledge, the ledge may have a groove sized to receive the ring.

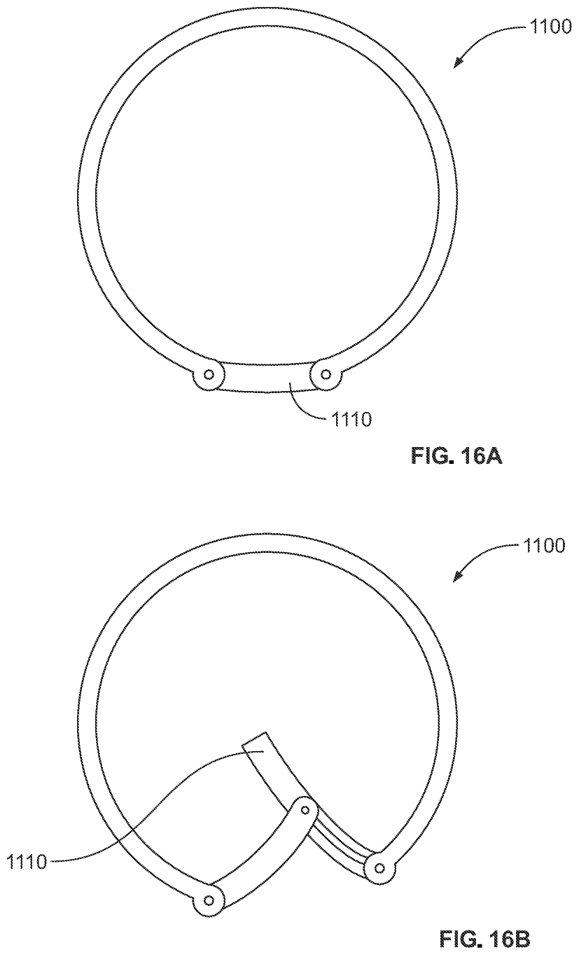

In yet another embodiment, a rigid expansion ring may be employed as a fastener instead of an arc adjustable band, a reverse hose clamp, a flanged sealing ring, or a snap ring. FIGS. 16A and 16B are front views of an expansion ring 1100 in closed and opened positions, respectively.

In the illustrated embodiment, the rigid expansion ring 1100 has a release handle 1110. When the expansion ring 1100 is in an expanded state, as shown in FIG. 16A, it has a first diameter. A user may pull on the handle 1110, which distorts the rigid expansion ring 1100 to contract from the expanded state having a first diameter to a deformed, compressed state, as shown in FIG. 16B.

In operation, when the rigid expansion ring 1100 is compressed to a deformed, compressed state, it may be inserted into or removed from a sealing position with respect to a curing envelope and a non-pneumatic tire. When the rigid expansion ring 1100 is in a sealing position, the handle 1110 may then be released such that the rigid expansion ring 1100 expands. When the ring 1100 expands, it abuts an end of the curing envelope and a ledge of an outer ring of the non-pneumatic tire. Thus, the rigid expansion ring 1100 seals the curing envelope against the non-pneumatic tire.

In one embodiment, the width of the rigid expansion ring 1100 is equal to the width of the ledge of the outer ring of the non-pneumatic tire. In an alternative embodiment, the compressible snap ring is wider than the ledge of the outer ring of the non-pneumatic tire. In another alternative embodiment, the compressible snap ring is narrower than the ledge of the outer ring of the non-pneumatic tire.

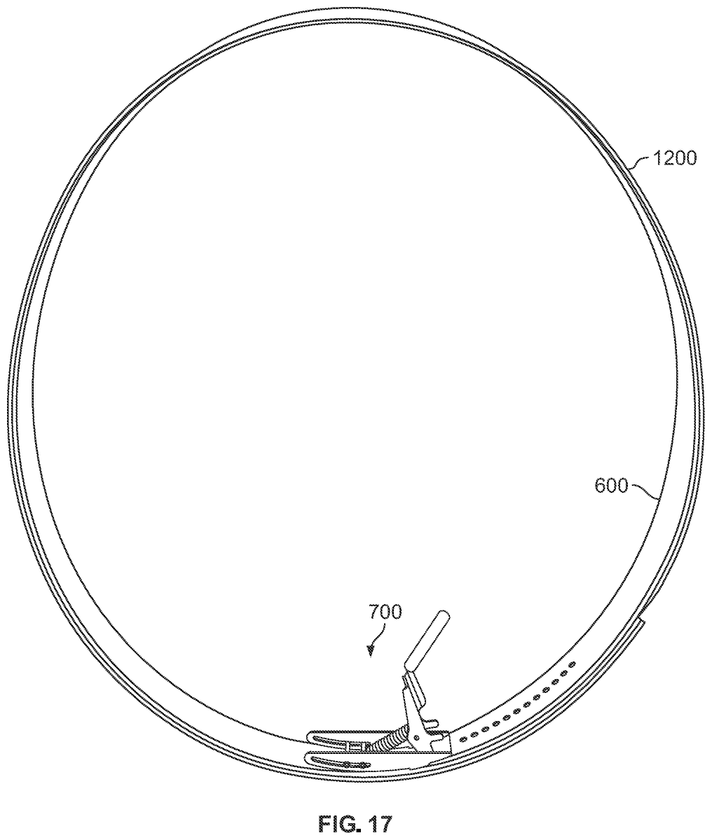

In many of the above-described embodiments, the fastener includes a flat ring or band. For example, the arc adjustable band 600, the reverse hose clamp 800, and the rigid expansion ring 1100 may each include a flat ring or band. In each of these embodiments, the flat ring or band may be constructed of steel or other metal. Additionally, in each of these embodiments, a flat, elastomeric belt may be disposed between the metal ring or band and the curing envelope. For example, FIG. 17 is a front view of the arc adjustable band 600 with a flat, elastomeric belt 1200 disposed about the outer circumference of the band 600. The flat, elastomeric belt 1200 may prevent damage to the curing envelope or to the arc adjustable band 600. The flat, elastomeric belt 1200 may be affixed to the arc adjustable band 600 by an adhesive or through other means. For example, the belt 1200 may be cured onto the arc adjustable band 600. Alternatively, the flat, elastomeric belt 1200 may be detached from the arc adjustable band 600, and may be separately placed into a sealing position between the curing envelope and the arc adjustable band 600.

While FIG. 17 only illustrates the flat, elastomeric belt 1200 with the arc adjustable band 600, it should be understood that a flat, elastomeric belt may be employed with any of the flat rings or bands described above.

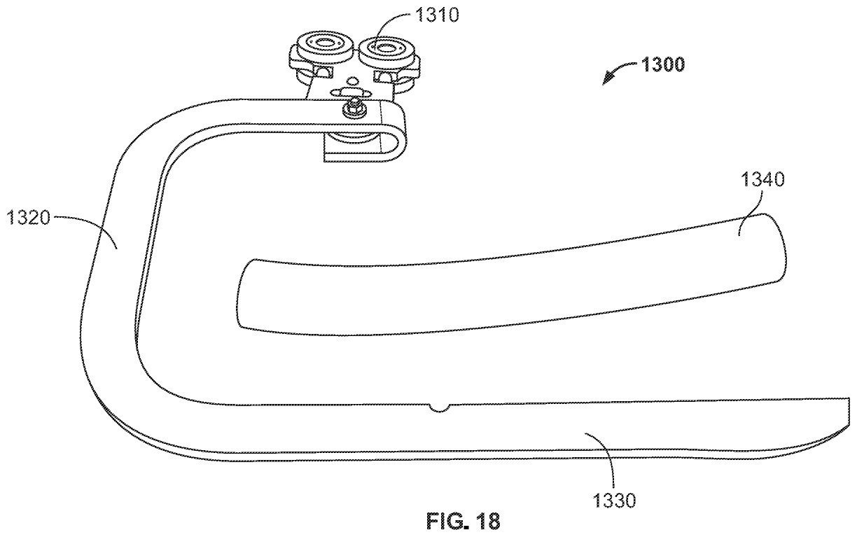

To transport a non-pneumatic tire, both before and after a tread has been applied to the non-pneumatic tire structure, a monorail system may be employed. A hanger for receiving the tire may extend from the monorail system. FIG. 18 is a front view of one embodiment of a hanger 1300 for a non-pneumatic tire. The hanger 1300 includes a pair of rollers 1310 for engaging the monorail (not shown). The hanger 1300 further includes a vertical member 1320 and a horizontal receiving portion 1330.

Hangers for pneumatic tires are known in the art. In contrast to conventional hangers, the hanger 1300 has a shorter vertical member 1320 and a longer horizontal receiving portion 1330. In one known embodiment, the vertical member 1320 is between 8 inches (20 cm) and 12 inches (30 cm) long and the horizontal receiving portion 1330 is between 14 inches (35 cm) and 18 inches (46 cm) long.

The horizontal receiving portion 1330 has a flat top surface, and may be covered with a rubber hose 1340 to protect the inner ring of a non-pneumatic tire. In an alternative embodiment (not shown), a rubber sleeve may be affixed to the horizontal receiving portion. In another alternative embodiment (not shown), a rubber coating may be applied to the horizontal receiving portion.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A method of making a non-pneumatic tire, the method comprising:
providing a tire structure including:
a lower ring having a first diameter and a first width,
an upper ring having a second diameter greater than the first diameter and a second width, the upper ring being substantially coaxial with the lower ring, and
a support structure extending between the lower ring and the upper ring, the support structure having a third width that is less than the second width, such that a first side of the upper ring extends outward from a first side of the support structure, thereby defining a first ledge, and such that a second side of the upper ring extends outward from a second side of the support structure, thereby defining a second ledge;
providing an elastomeric tread circumferentially about a top of the upper ring;
securing a curing envelope about the elastomeric tread, including the steps of securing a first side of the curing envelope to a bottom of the first ledge of the upper ring and securing a second side of the curing envelope to a bottom of the second ledge of the upper ring; and
applying heat within the curing envelope.

2. The method of claim 1, wherein the securing of the curing envelope about the elastomeric tread includes securing each end of the curing envelope to the first ledge and the second ledge with an arc adjustable band.

3. The method of claim 1, wherein the securing of the curing envelope about the elastomeric tread includes securing each end of the curing envelope to the first ledge and the second ledge with a reverse hose clamp.

4. The method of claim 1, wherein the securing of the curing envelope about the elastomeric tread includes securing each end of the curing envelope to the first ledge and the second ledge with a sealing ring having an upper flange and a lower flange, wherein the upper flange and lower flange are spaced apart by a distance substantially the same as a combined height of the upper ring and the elastomeric tread.

5. The method of claim 1, wherein the securing of the curing envelope about the elastomeric tread includes securing each end of the curing envelope to the first ledge and the second ledge with an elastomeric belt.

6. The method of claim 1, wherein the securing of the curing envelope about the elastomeric tread includes securing each end of the curing envelope to the first ledge and the second ledge with an expansion ring.

7. The method of claim 1, wherein the securing of the curing envelope about the elastomeric tread includes securing each end of the curing envelope to the first ledge and the second ledge with a snap ring.

8. A system for assembling a circumferential tread and a non-pneumatic tire structure having an upper ring, a lower ring, and support structure extending between the upper ring and the lower ring, the system comprising:
a curing envelope dimensioned to receive an upper ring of a non-pneumatic tire structure and a circumferential tread,
wherein the curing envelope includes a first side configured to be secured to a bottom of a first ledge of the upper ring, and
wherein the curing envelope includes a second side configured to be secured to a bottom of a second ledge of the upper ring;
a first fastener configured to secure the first side of the curing envelope to the bottom of the first ledge of the upper ring, and
a second fastener configured to secure the second side of the curing envelope to the bottom of the second ledge of the upper ring.

9. The system of claim 8, wherein at least one of the first fastener and the second fastener is an adjustable band with a first end having a plurality of apertures along its length, and a second end having a ratchet assembly secured thereto, wherein the ratchet assembly is configured to engage at least one of the apertures to maintain the adjustable band in a substantially circular configuration.

10. The system of claim 9, wherein the ratchet assembly includes a curved body secured to the second end of the adjustable band, and a handle pivotally connected to the curved body.

11. The system of claim 8, wherein at least one of the first fastener and the second fastener is a reverse hose clamp with a first end having a plurality of slots along its length, and a second end having a helicoid screw assembly secured thereto, wherein the helicoid screw assembly is configured to engage a plurality of the slots to maintain the reverse hose clamp in a substantially circular configuration.

12. The system of claim 8, wherein at least one of the first fastener and the second fastener is a sealing ring having an upper flange and a lower flange, wherein the upper flange and lower flange are spaced apart by a distance substantially the same as a combined height of the upper ring and the circumferential tread.

13. The system of claim 8, wherein at least one of the first fastener and the second fastener includes a flat, elastomeric belt.

14. The system of claim 8, wherein at least one of the first fastener and the second fastener is a rigid expansion ring having a release handle that distorts the rigid expansion ring to contract from an expanded state to a compressed, deformed state.

15. The system of claim 8, wherein at least one of the first fastener and the second fastener is a compressible snap ring.

16. A non-pneumatic tire comprising:
a lower ring having a first diameter and a first width;
an upper ring having a second diameter greater than the first diameter and a second width, the upper ring being substantially coaxial with the lower ring;
a support structure extending between the lower ring and the upper ring,
wherein the support structure has a third width that is less than the second width,
wherein the support structure is affixed to the upper ring such that a first side of the upper ring extends outward from a first side of the support structure, thereby defining a first ledge, and
wherein the support structure is affixed to the upper ring such that a second side of the upper ring extends outward from a second side of the support structure, thereby defining a second ledge; and
an elastomeric tread circumferentially affixed to a top of the upper ring, wherein no pressure-sensitive adhesive is disposed between the upper ring and the elastomeric tread.

17. The non-pneumatic tire of claim 16, wherein the upper ring is a steel band.

18. The non-pneumatic tire of claim 16, wherein a strip of cured rubber is disposed between the elastomeric tread and the upper ring.

19. The non-pneumatic tire of claim 16, wherein the first width of the lower ring is substantially the same as the third width of the support structure.

20. The non-pneumatic tire of claim 16, wherein the first width of the lower ring is substantially the same as the second width of the upper ring.
